(19) United States
(12) Patent Application Publication
(10) Pub. No.: US 2011/0120390 A1
(43) Pub. Date: May 26, 2011

(54) Pet Strap Assembly Having Buffering Effect

(76) Inventor: Kun-Tan Kung, Long Ching Hsiang (TW)

(21) Appl. No.: 12/624,665

(22) Filed: Nov. 24, 2009

(51) Int. Cl. A01K 27/00

(52) U.S. Cl. 119/798

(57) ABSTRACT

A pet strap assembly includes a drawing unit and a pulling unit detachably connected with the drawing unit. The drawing unit includes an elastic strap. The elastic strap includes an outer layer, at least one inner layer mounted in and surrounded by the outer layer and a plurality of resilient strips mounted in and surrounded by the at least one inner layer. Thus, the elastic drawing unit provides an elastic buffering effect to the user by the elastic action of the resilient strips to reduce the reaction applied by the pet on the user's hand to the minimum extent, thereby preventing the user's wrist from being hurt when the pet is running violently.

### BACKGROUND OF THE INVENTION

1. Field of the Invention

The present invention relates to a strap and, more particularly, to a pet strap assembly to draw and limit movement of a pet, such as a dog or the like.

2. Description of the Related Art

A conventional pet strap assembly 1 in accordance with the prior art shown in FIG. 5 comprises a pulling strap 11 having a first portion provided with a loop 12 to facilitate a user holding the pulling strap 11, a retaining member 13 mounted on a second portion of the pulling strap 11, and a turnbuckle 14 pivotally mounted on the retaining member 13 and snapped onto a neck collar (not shown) of a pet, such as a dog or the like. Thus, after the turnbuckle 14 is locked onto the neck collar of the pet, the user's hand can hold the loop 12 to draw and limit movement of the pet. However, the pulling strap 11 cannot provide a buffering effect to the user to reduce the reaction applied by the pet on the user's hand, so that the user's wrist is easily hurt when the pet is running violently. In addition, the pulling strap 11 will be rotated by the pet when the pet is rolling or running irregularly, so that the pulling strap 11 is easily tangled, and the user's wrist is easily hurt when the pet is rolling or running violently.

### BRIEF SUMMARY OF THE INVENTION

In accordance with the present invention, there is provided a pet strap assembly, comprising a drawing unit and a pulling unit detachably connected with the drawing unit. The drawing unit includes an elastic strap. The elastic strap of the drawing unit includes an outer layer, at least one inner layer mounted in and surrounded by the outer layer and a plurality of resilient strips mounted in and surrounded by the at least one inner layer.

The primary objective of the present invention is to provide a pet strap assembly having an elastic buffering effect.

According to the primary objective of the present invention, the elastic drawing unit provides an elastic buffering effect to the user by the elastic action of the resilient strips to reduce the reaction and stress applied by the pet on the user's hand to the minimum extent, thereby preventing the user's wrist from being hurt when the pet is running violently.

According to another objective of the present invention, the resilient strips are surrounded by the at least one inner layer, and the at least one inner layer is surrounded by the outer layer, so that when the resilient strips and the at least one inner layer are broken due to an excessive pulling force, the resilient strips are limited by the outer layer and will not being sprung outward, thereby preventing the user from being hurt by the broken resilient strips.

According to a further objective of the present invention, the turnbuckle is pivotally mounted on the elastic strap, and the second turnbuckle is pivotally mounted on the pulling strap, so that the pulling unit will not be rotated in concert with the drawing unit when the drawing unit is rotated or rolled by the pet, thereby preventing the pulling unit from being tangled, and thereby preventing the user's wrist from being hurt when the pet is rolling violently.

According to a further objective of the present invention, the outer layer surrounds the at least one inner layer to enhance the strength of the at least one inner layer to prevent the at least one inner layer from being broken.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a pet strap assembly in accordance with the preferred embodiment of the present invention.

FIG. 2 is a partially perspective broken cross-sectional view of an elastic strap of the pet strap assembly as shown in FIG. 1.

FIG. 3 is a partially perspective broken cross-sectional view of an elastic strap of the pet strap assembly in accordance with another preferred embodiment of the present invention.

FIG. 4 is a partially perspective broken cross-sectional view of an elastic strap of the pet strap assembly in accordance with another preferred embodiment of the present invention.

FIG. 5 is a perspective view of a conventional pet strap assembly in accordance with the prior art.

### DETAILED DESCRIPTION OF THE INVENTION

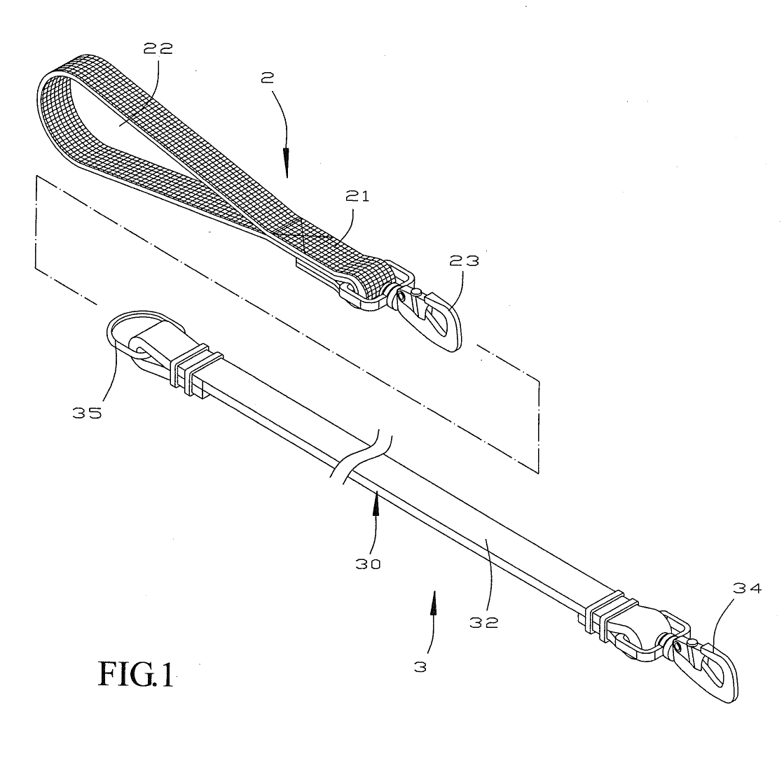

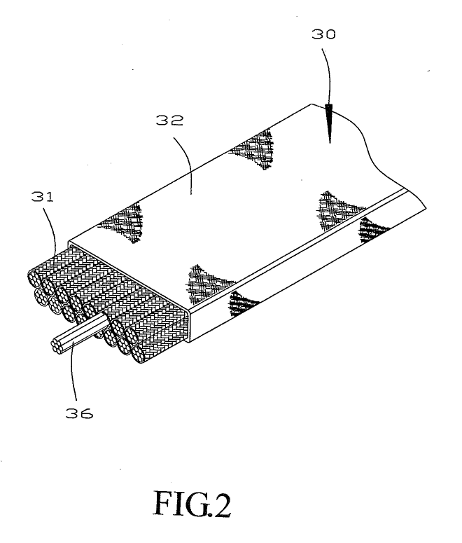

Referring to the drawings and initially to FIGS. 1 and 2, a pet strap assembly in accordance with the preferred embodiment of the present invention comprises a drawing unit 3 and a pulling unit 2 detachably connected with the drawing unit 3.

The drawing unit 3 includes an elastic strap 30, a connecting ring 35 pivotally mounted on a first end of the elastic strap 30 and a turnbuckle 34 pivotally mounted on a second end of the elastic strap 30. The turnbuckle 34 of the drawing unit 3 is detachably locked onto a neck collar (not shown) of a pet, such as a dog or the like.

The elastic strap 30 of the drawing unit 3 includes an outer layer 32, at least one inner layer 31 mounted in and surrounded by the outer layer 32 and a plurality of resilient strips 36 mounted in and surrounded by the at least one inner layer 31.

The outer layer 32 of the elastic strap 30 is a knitting fabric formed by a knitting machine. The outer layer 32 of the elastic strap 30 has a substantially hollow rectangular cross-sectional profile. The at least one inner layer 31 of the elastic strap 30 is a weaving fabric formed by a weaving machine. Preferably, the elastic strap 30 of the drawing unit 3 includes a plurality of inner layers 31 each having a hollow inside containing a plurality of resilient strips 36. Each of the inner layers 31 of the elastic strap 30 has a substantially tubular cross-sectional profile. Each of the resilient strips 36 of the elastic strap 30 is made of a resilient material, such as latex, gel, lactoprene and the like. Each of the resilient strips 36 of the elastic strap 30 has a substantially circular cross-sectional profile.

The pulling unit 2 includes a pulling strap 21 having a first portion provided with a loop 22 to facilitate a user holding the pulling unit 2 and a second turnbuckle 23 pivotally mounted on a second end of the pulling strap 21 and detachably locked onto the connecting ring 35 of the drawing unit 3.

When in use, after the turnbuckle 34 of the drawing unit 3 is locked onto the neck collar of the pet, the user's hand can hold the loop 22 of the pulling unit 2 to draw and limit movement of the pet.

Accordingly, the elastic drawing unit 3 provides an elastic buffering effect to the user by the elastic action of the resilient strips 36 to reduce the reaction and stress applied by the pet on the user's hand to the minimum extent, thereby preventing the user's wrist from being hurt when the pet is running violently. In addition, the resilient strips 36 are surrounded by the at least one inner layer 31, and the at least one inner layer 31 is surrounded by the outer layer 32, so that when the resilient strips 36 and the at least one inner layer 31 are broken due to an excessive pulling force, the resilient strips 36 are limited by the outer layer 32 and will not being sprung outward, thereby preventing the user from being hurt by the broken resilient strips 36. Further, the turnbuckle 34 is pivotally mounted on the elastic strap 30, and the second turnbuckle 23 is pivotally mounted on the pulling strap 21, so that the pulling unit 2 will not be rotated in concert with the drawing unit 3 when the drawing unit 3 is rotated or rolled by the pet, thereby preventing the pulling unit 2 from being tangled, and thereby preventing the user's wrist from being hurt when the pet is rolling violently. Further, the outer layer 32 surrounds the at least one inner layer 31 to enhance the strength of the at least one inner layer 31 to prevent the at least one inner layer 31 from being broken.

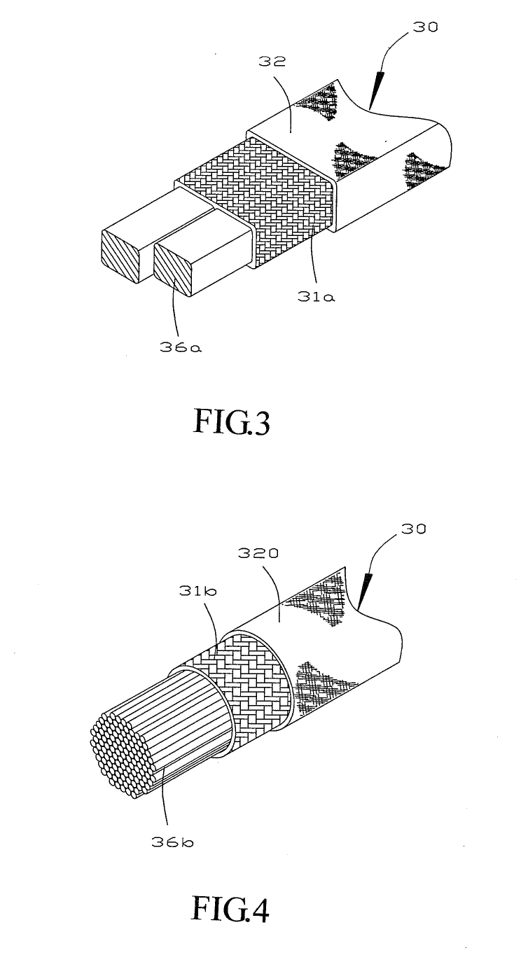

Referring to FIG. 3, the at least one inner layer 31a of the elastic strap 30 has a substantially hollow rectangular cross-sectional profile, and each of the resilient strips 36a of the elastic strap 30 has a substantially rectangular cross-sectional profile.

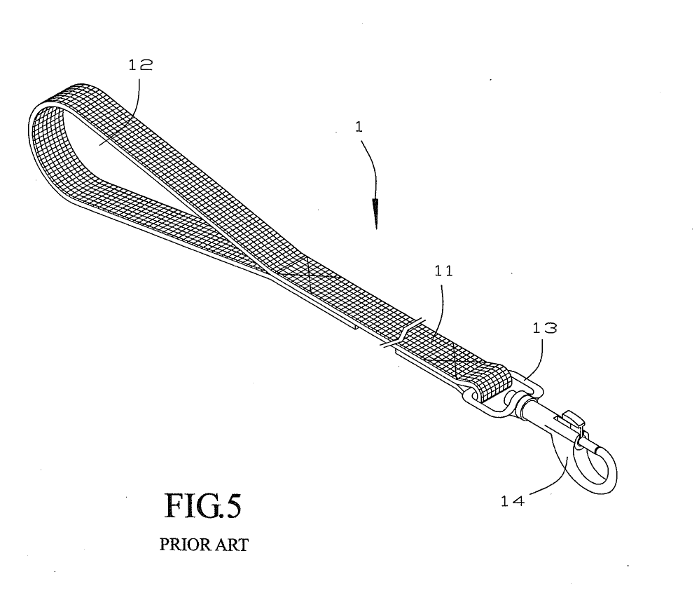

Referring to FIG. 4, the outer layer 32b of the elastic strap 30 has a substantially tubular cross-sectional profile, the at least one inner layer 31b of the elastic strap 30 has a substantially tubular cross-sectional profile, and each of the resilient strips 36b of the elastic strap 30 has a substantially circular cross-sectional profile.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pet strap assembly, comprising:
a drawing unit;
a pulling unit detachably connected with the drawing unit; wherein:
the drawing unit includes an elastic strap;
the elastic strap of the drawing unit includes:
an outer layer;
at least one inner layer mounted in and surrounded by the outer layer;
a plurality of resilient strips mounted in and surrounded by the at least one inner layer.

2. The pet strap assembly of claim 1, wherein the outer layer of the elastic strap is a knitting fabric formed by a knitting machine.

3. The pet strap assembly of claim 1, wherein the at least one inner layer of the elastic strap is a weaving fabric formed by a weaving machine.

4. The pet strap assembly of claim 1, wherein each of the resilient strips of the elastic strap is made of latex.

5. The pet strap assembly of claim 1, wherein each of the resilient strips of the elastic strap is made of gel.

6. The pet strap assembly of claim 1, wherein each of the resilient strips of the elastic strap is made of lactoprene.

7. The pet strap assembly of claim 1, wherein the elastic strap of the drawing unit includes a plurality of inner layers each having a hollow inside containing a plurality of resilient strips.

8. The pet strap assembly of claim 1, wherein the outer layer of the elastic strap has a substantially hollow rectangular cross-sectional profile.

9. The pet strap assembly of claim 1, wherein
each of the inner layers of the elastic strap has a substantially tubular cross-sectional profile;
each of the resilient strips of the elastic strap has a substantially circular cross-sectional profile.

10. The pet strap assembly of claim 1, wherein
the at least one inner layer of the elastic strap has a substantially hollow rectangular cross-sectional profile;
each of the resilient strips of the elastic strap has a substantially rectangular cross-sectional profile.

11. The pet strap assembly of claim 1, wherein
the outer layer of the elastic strap has a substantially tubular cross-sectional profile;
the at least one inner layer of the elastic strap has a substantially tubular cross-sectional profile;
each of the resilient strips of the elastic strap has a substantially circular cross-sectional profile.

12. The pet strap assembly of claim 1, wherein the drawing unit further includes:
a connecting ring pivotally mounted on a first end of the elastic strap;
a turnbuckle pivotally mounted on a second end of the elastic strap;
the pulling unit includes:
a pulling strap having a first portion provided with a loop;
a second turnbuckle pivotally mounted on a second end of the pulling strap and detachably locked onto the connecting ring of the drawing unit.
